(19) United States
(12) Patent Application Publication
(10) Pub. No.: US 2019/0028605 A1
(43) Pub. Date: Jan. 24, 2019

(54) METHOD AND APPARATUS FOR CROPPING AND DISPLAYING AN IMAGE

(71) Applicant: Motorola Solutions, Inc., Chicago, IL (US)

(72) Inventors: CHEW YEE KEE, ALOR SETAR (MY); MUN YEW THAM, BAYAN LEPAS (MY); ALFY MERICAN AHMAD HAMBALY, BAYAN BARU (MY); BING QIN LIM, JELUTONG (MY)

(21) Appl. No.: 15/657,245

(22) Filed: Jul. 24, 2017

(51) Int. Cl. H04N 1/387; G06T 11/60; H04W 4/12; G06F 17/24

(52) U.S. Cl. CPC H04N 1/3871; G06T 11/60; G06T 2207/20132; G06F 17/241; H04N 1/3875; H04W 4/12

(57) ABSTRACT

A method and apparatus for cropping annotated images are provided herein. During operation an image will be analyzed to determine any annotation existing within the image. When annotation exists, the annotated portion is cropped and displayed as the preview (thumbnail) within, for example, a messaging application.

### BACKGROUND OF THE INVENTION

Sending someone an annotated image is a very useful method to communicate. However a problem exists when a thumbnail of the annotated image is created without showing the annotation. For example, many texting applications create a smaller preview image by cropping the whole image and using only the center of whole image for the preview image. Since the annotated portion of an image may not exist in the center of the image, the preview image may not show any annotation. This is illustrated in FIG. 1.

As shown in FIG. 1, a user has created an image to say “thanks” to team “hackers”. As part of this image, the user has annotated the image with a time and date of a party. This is illustrated in FIG. 1 as annotation 101. Once the image has been sent in a text, the texting application crops the center portion of the image to display within the text message. This is illustrated in FIG. 1 as image 102. As is evident, the information about the time and date of the party is left out of the cropped image. Because of this, valuable information may be passed up by the person who receives the text.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates an annotated image that has been cropped via prior-art techniques.

FIG. 2 illustrates an annotated image that has been cropped.

FIG. 3 is a block diagram of a device that crops annotated images.

FIG. 4 is a flow chart showing operation of the device of FIG. 3.

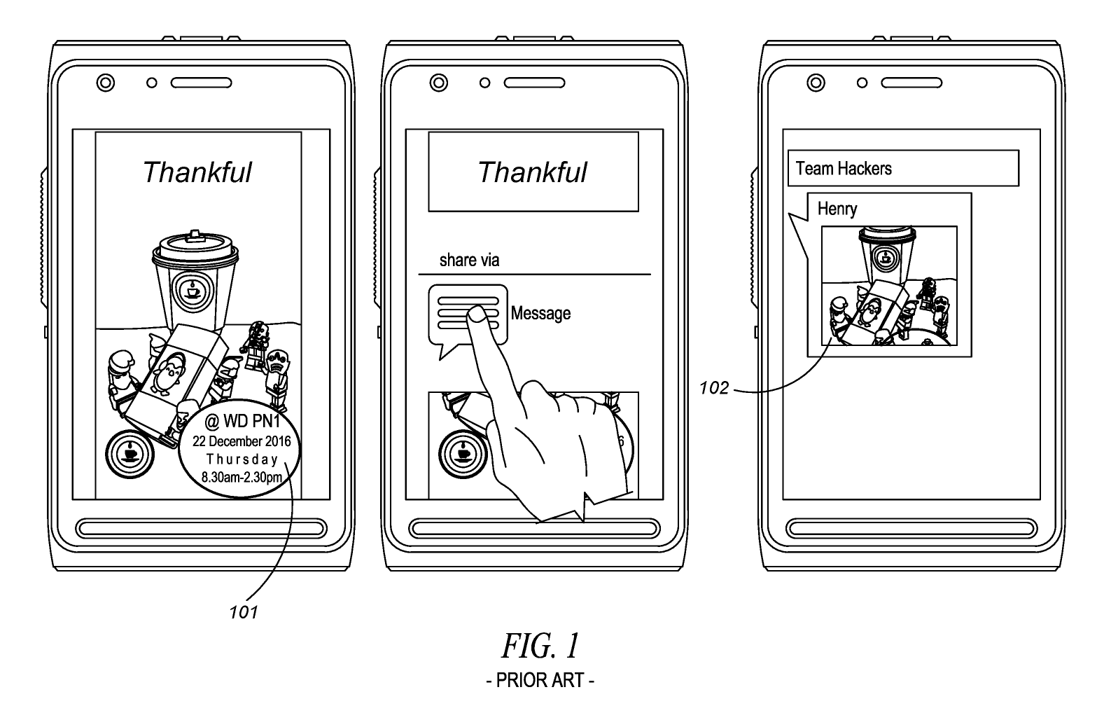

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above mentioned need, a method and apparatus for cropping annotated images are provided herein. During operation an image will be analyzed to determine any annotation (for example, text, shape, line, handwriting, and highlighting) existing within the image. When annotation exists, the annotated portion is cropped and displayed as the preview (thumbnail) within, for example, a messaging application.

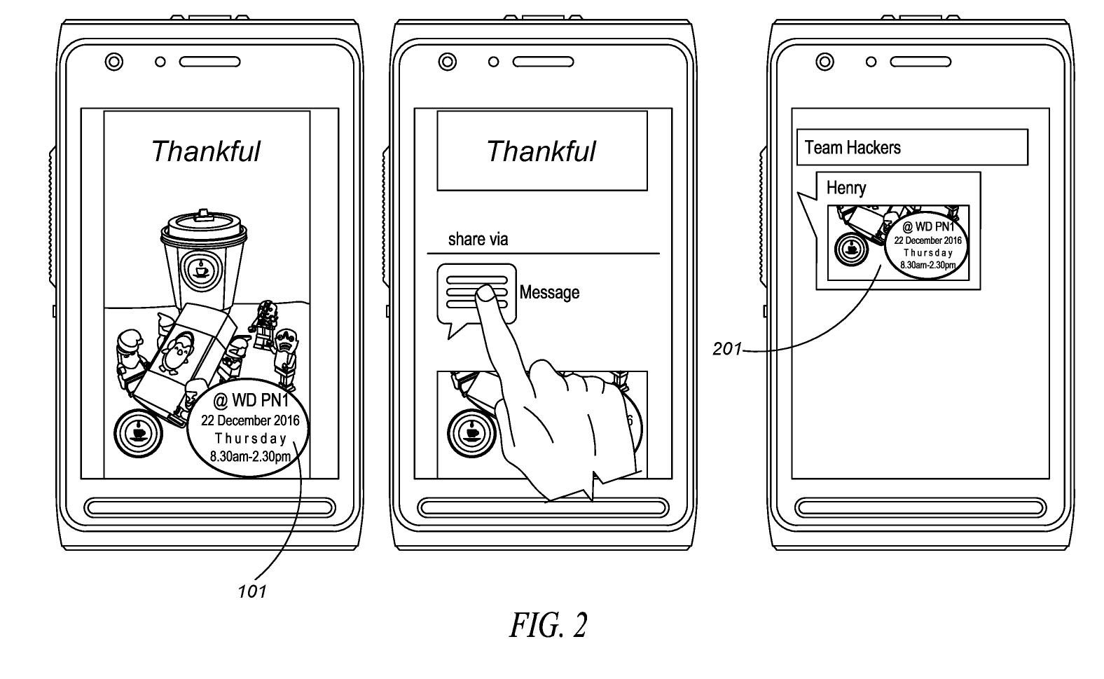

By displaying a thumbnail comprising the annotated portion of an image, important information will be conveyed to the user in the thumbnail. This is illustrated in FIG. 2. More specifically, in FIG. 2, a user has created an image to say “thanks” to team “hackers”. As part of this image, the user has annotated the image with a time and date of a party. This is illustrated in FIG. 2 as annotation 101. Once the image has been sent in a text, the texting application crops the portion of the image containing the text in order to display within the text message. This is illustrated in FIG. 2 as image 201. As is evident, the information about the time and date of the party is still maintained in the cropped image.

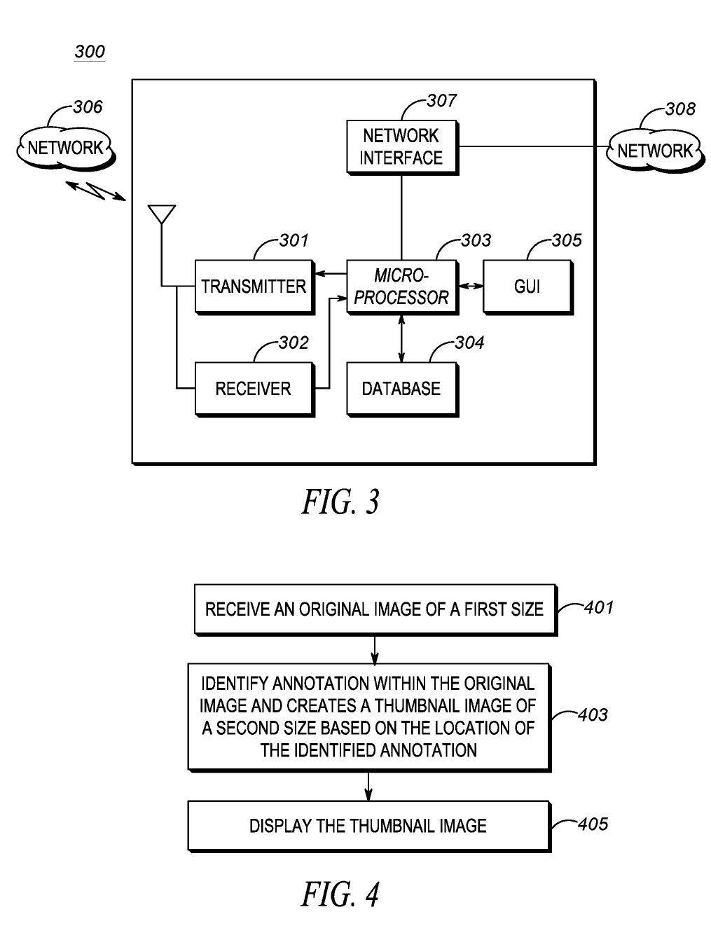

FIG. 3 is a block diagram of a device that receives an original image and creates a thumbnail of the image, wherein the thumbnail of the image is created to include any annotation that exists within the original image. The term “thumbnail” is a term used in the art for a small image representation of a larger image. For example, thumbnails may provide a miniaturized version of multiple images in a file system so that you don't have to remember the file name of each image. Additionally, web sites with many pictures, such as online stores with visual catalogs, often provide thumbnail images instead of larger images to make the page download faster. The user controls which images need to be seen in full size.

As shown in FIG. 3, device 300 may include transmitter 301, receiver 302, graphical-user interface (GUI) 305, logic circuitry 303, memory 304, and network interface 307. In other implementations, device 300 may include more, fewer, or different components. Device 300 may comprise a Smartphone, computer, police radio, or any other device capable of displaying images.

Graphical-User Interface (GUI) 305 comprises a screen (e.g., a liquid crystal display (LCD), organic light-emitting diode (OLED) display, surface-conduction electro-emitter display (SED), plasma display, field emission display (FED), bistable display, projection display, laser projection, holographic display, etc.) that can display images, maps, incident data, . . . , etc. GUI 305 receives an input from a user to initiate an attempt to view an image. The input may comprise a command to read a text, display a file, . . . , etc. In order to provide the above thumbnail, GUI 305 may include a monitor, a keyboard, a mouse, and/or various other hardware components to provide a man/machine interface.

Logic circuitry 303 comprises a digital signal processor (DSP), general purpose microprocessor, a programmable logic device, or application specific integrated circuit (ASIC) and is utilized to receive an image and generate thumbnail of the image comprising annotation within the thumbnail.

Memory 304 comprises standard random-access memory, and is used to store images.

Device 300 may receive images over a hard-wired network 308, or a wireless network 307. Both types of networks are shown in FIG. 3; however one of ordinary skill in the art will recognize that device 300 may comprise a connection to a single type of network. In an illustrative embodiment, network 106 is attached (i.e., connected) to device 300 through network interface 307 and communicates with processor 303. Network interface 307 includes elements including processing, modulating, and transceiver elements that are operable in accordance with any one or more standard or proprietary wired interfaces, wherein some of the functionality of the processing, modulating, and transceiver elements may be performed by means of processor 303.

In the illustrative embodiment, wireless network 104 is attached (i.e., connected) to device 300 through transmitter 301 and receiver 302 both of which communicate with processor 303. Network 104 is connected to device 300 via a wireless connection, although this connection may be wired in alternate embodiments.

Transmitter 301 and receiver 302 are preferably wireless, and may be long-range and/or short-range transceivers that utilize a private 802.11 network set up by a building operator, a next-generation cellular communications network operated by a cellular service provider, or any public-safety network such as an APCO 25 network or the FirstNet broadband network. Transmitter 301 and receiver 302 may also contain multiple transmitters and receivers, to support multiple communications protocols simultaneously. For example, transmitter 301 and receiver 302 may use a first communication-system protocol for communicating with officer 101 over network 104, and use a second communication-system protocol for communicating with server 107 over network 106.

During operation1, network interface 307 and/or receiver 302 receives an original image. The original image may be received via a text message, an email message, a received file, or any other form. Logic circuitry 303 stores the original image in database 304. Logic circuitry 303 identifies annotation within the original image and creates a thumbnail image based on the identified annotation. The thumbnail image is also stored in database 304. The memory 304 can be used to store an annotation recognition library (e.g. library for plurality of shapes, lines, symbols, handwriting example) as well to correlate and identify the annotation. As discussed above, the thumbnail comprises a miniaturized image of the original image (i.e., miniaturized in file size and/or in pixels). Finally, graphical-user interface (GUI) 305 displays the thumbnail image. An action upon the thumbnail image produces the original image on GUI 305. For example, a “double-click”, a “long press”, . . . , etc. on the thumbnail will cause processor 303 to retrieve the original image from database 304 and display the original image on GUI 305.

There are multiple ways that annotation may be detected within an image. The following are some examples that are not meant to limit the broader invention.

Optical Character Recognition—OCR (optical character recognition) is the recognition of printed or written text characters by a processor 303. This involves analysis of the original image for characters, which are translated into character codes, such as ASCII, commonly used in data processing. In OCR processing, the image is analyzed for light and dark areas in order to identify each alphabetic letter or numeric digit. When a character is recognized, it is converted into an ASCII code. Special processors designed expressly for OCR may be used to speed up the recognition process.

Solid Color—When a photo is captured, it is not likely that there is a continuous/large portion of solid color (photo pixels that contain exactly same RGB color code/info). With this in mind, processor 303 can assume that when a large portion of an image is a solid color, this portion comprises annotation. Thus when a large, continuous portion (e.g., over 5%) of the image is detected to have same color, that portion may considered to be an annotation.

Particular Shape—Processor 303 may be configured to detect a particular geometric shape (e.g., square, circle, arrow, rectangle, . . . , etc.). This may be accomplished, for example, by accessing a shape library in memory 304, and comparing any detected shapes within the image to those within memory 304. If a match exists, then it may be assumed that annotation is contained within the shape.

Handwriting—Processor 303 may detect handwriting within the image. If detected, it may be assumed that the handwriting comprises annotation.

Metadata—When an image is annotated, the application software can insert metadata that contains information related to the annotation that has been done within the image. For example, metadata may indicate a location of any annotation within the image (e.g., pixel location of a center of the annotation, area of the annotation in pixels, shape of the annotation (circle, square, . . . , etc.), . . . , etc.) This information may be used by processor 303 to determine the location and size of the annotation within the image.

Once annotation (text) has been identified in the original image, a thumbnail will be created of the original image. As discussed above, the thumbnail will be an image of a particular size that is smaller than the original image. While there are multiple ways of creating this thumbnail to include the annotation, some examples follow:

Centering the Annotation within the Thumbnail—The annotation size or boundary can be determined by processor 303, and the image may be cropped to an N×M thumbnail so that the annotation is at the center of the N×M thumbnail.

Cropping the Center of the Image if Annotation is Included within the Cropped Image—An N×M thumbnail may be cropped from the center of the image if the annotation is part of the thumbnail. In this example, the center of the image might not be the annotation portion, however, the annotation will still be included within the N×M thumbnail.

Forming an annotation collage—When multiple annotations are detected, processor 303 can crop each annotated portion of the image and stitch them together and form an image collages as single thumbnail.

Creating Multiple Annotated Images from a Single Image—When processor 303 detects multiple annotations within a single image, multiple thumbnails can be made, each of the multiple thumbnails capturing a particular annotation. These multiple annotations can then be sent to users, via, for example, a text message. When the multiple images are received, the receiver can perform a gesture (e.g. swipe left or right, dedicated “next” button) to swipe to the multiple annotated images. The annotated images can be presented to the receiver user in certain predetermined order (e.g., a chronological order of the time the annotation is performed through metadata info of the original image and the metadata of the group images that has been sent). The metadata may comprise a timestamp of the annotation being made or sequence information of the annotation being made.

FIG. 4 is a flow chart showing operation of the apparatus of FIG. 3. The logic flow begins at step 401 where a network interface receives an original image of a first size. As discussed above, network interface may be wired (e.g., interface 307) or wireless (e.g., receiver 302). At step 403, logic circuitry 303 identifies annotation within the original image and creates a thumbnail image of a second size based on the location of the identified annotation. Graphical-user interface (GUI) then displays the thumbnail image, wherein an action upon the thumbnail image produces the original image (step 405).

As discussed above, the logic circuitry may identify the annotation within the image by performing optical character recognition on the original image and identifying the annotation as recognized characters, detecting a portion of the original image that comprises a solid single color, by detecting a particular shape within the original image and identifying the particular shape as annotation by detecting handwriting within the original image and identifying the handwriting as annotation, or by detecting if annotation is identified within the image from metadata.

As discussed above, memory 304 may be provided for storing both the original image and the thumbnail image, where the thumbnail image comprises a miniaturized image of the original image. Memory 304 may also be used for storing an annotation pattern library that identifies annotations. The annotations may comprise text, a shape, a symbol, handwriting, or highlighting within the original image.

As discussed above, the thumbnail may comprise multiple annotated portions of the original image that have been cropped and stitched together to form the thumbnail. When this occurs, logic circuitry 303 identifies multiple areas of annotation within the original image and creates the multiple thumbnail images of the original image, wherein the multiple thumbnail images comprise the multiple areas of annotation.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
a network interface receiving an original image;
logic circuitry identifying annotation within the original image and creating a thumbnail image based on a location of the identified annotation;
a graphical-user interface (GUI) displaying the thumbnail image, wherein an action upon the thumbnail image produces the original image.

2. The apparatus of claim 1 wherein the network interface comprises a wireless receiver receiving the original image via an over-the-air transmission.

3. The apparatus of claim 1 wherein the network interface comprises a wireless receiver receiving the original image via a text message.

4. The apparatus of claim 1 wherein the logic circuitry identifies the annotation within the original image by performing optical character recognition on the original image and identifying the annotation as recognized characters.

5. The apparatus of claim 1 wherein the logic circuitry identifies the annotation within the original image by detecting a portion of the original image that comprises a solid single color.

6. The apparatus of claim 1 wherein the logic circuitry identifies the annotation within the original image by detecting a particular shape within the original image and identifying the particular shape as annotation.

7. The apparatus of claim 1 wherein the logic circuitry identifies the annotation within the original image by detecting handwriting within the original image and identifying the handwriting as annotation.

8. The apparatus of claim 1 wherein the logic circuitry identifies the annotation within the original image by detecting if annotation is identified within the image from metadata.

9. The apparatus of claim 1 further comprising a memory storing both the original image and the thumbnail image.

10. The apparatus of claim 1 wherein the thumbnail image comprises a miniaturized image of the original image.

11. The apparatus of claim 1 wherein the annotation comprises text, a shape, a symbol, handwriting, or highlighting within the original image.

12. The apparatus of claim 1 further comprising a memory storing an annotation pattern library.

13. The apparatus of claim 1 wherein the thumbnail comprises multiple annotated portions of the original image that have been cropped and stitched together to form the thumbnail.

14. The apparatus of claim 1 wherein the logic circuitry identifies multiple areas of annotation within the original image and creates multiple thumbnail images of the original image, wherein the multiple thumbnail images comprise the multiple areas of annotation.

15. A method for creating a thumbnail image, the method comprising the steps of:
receiving an original image;
identifying annotation within the original image and creating a thumbnail image based on a location of the identified annotation;
displaying the thumbnail image, wherein an action upon the thumbnail image produces the original image.
